(19) United States
(12) Patent Application Publication
(10) Pub. No.: US 2024/0190131 A1
(43) Pub. Date: Jun. 13, 2024

(54) HEAD CHIP, LIQUID JET HEAD, AND LIQUID JET RECORDING DEVICE

(71) Applicant: Sll Printek Inc., Chiba-shi (JP)

(72) Inventors: Daichi NISHIKAWA, Chiba-shi (JP); Takanori KOYANO, Chiba-shi (JP)

(21) Appl. No.: 18/528,096

(22) Filed: Dec. 4, 2023

(30) Foreign Application Priority Data
Dec. 7, 2022 (JP) 2022-195603

(51) Int. Cl. B41J 2/16; B41J 2/14; B41J 2/175

(52) U.S. Cl. CPC B41J 2/1623; B41J 2/1433; B41J 2/164; B41J 2/175; B41J 2002/14419; B41J 2002/14491; B41J 2202/20

(57) ABSTRACT

There are provided a head chip, a liquid jet head, and a liquid jet recording device which smoothly circulates ink between pressure chambers and a circulation channel to thereby prevent disappearance of a protective film to improve durability. The head chip according to an aspect of the present disclosure includes an ejection section, a jet hole plate, a return plate, a flow channel plate, and a protective film. A communication channel includes an upstream opening communicated with a channel opening which opens toward a first side in a first direction in a jet channel, a downstream opening communicated with a manifold opening which opens toward the first side in the first direction in the manifold, and a connecting part which extends in a third direction, and which is configured to connect the upstream opening and the downstream opening to each other. The return plate is bonded to the ejection section so that at least a part of an opening edge in the upstream opening is arranged at an outer side when viewed from the first direction with respect to an opening edge of the channel opening.

### RELATED APPLICATIONS

This application claims priority to Japanese Patent application No. JP2022-195603, filed on Dec. 7, 2022, the entire content of which is incorporated herein by reference.

### BACKGROUND OF THE INVENTION

### 1. Field of the Invention

The present disclosure relates to a head chip, a liquid jet head, and a liquid jet recording device.

### 2. Description of the Related Art

As an inkjet head installed in an inkjet printer, there has been known one equipped with a circulation type head chip. The circulation type head chip is provided with a plurality of pressure chambers for pressurizing ink, a plurality of nozzle holes separately communicated with the respective pressure chambers, circulation paths separately disposed between the pressure chambers and the nozzle holes corresponding to each other, and a common flow channel to which the plurality of circulation paths is coupled in a lump (see, e.g., JP2009-56766A).

In the head chip of this kind, a part of the ink pressurized in the pressure chambers is ejected through the corresponding nozzle holes, while the rest of the ink flows into the common flow channel through the circulation paths.

However, in the related art described above, there has been a room for improvement in the point of smoothly circulating the ink between the pressure chambers and the circulation paths.

The present disclosure provides a head chip, a liquid jet head, and a liquid jet recording device each capable of smoothly circulating the ink between the pressure chambers and the circulation paths.

### SUMMARY OF THE INVENTION

In order to solve the problems described above, the present disclosure adopts the following aspects.

(1) A head chip according to an aspect of the present disclosure includes an ejection section having a plurality of jet channels which extends in a first direction, and which is arranged in a second direction crossing the first direction, and electrodes formed on inner surfaces of the jet channels, a jet hole plate which has a plurality of jet holes individually communicated with the plurality of jet channels, and which is arranged at a first side in the first direction of the ejection section, a return plate which has a plurality of communication channels configured to individually communicate the plurality of jet channels and the plurality of jet holes with each other, and which is arranged between the ejection section and the jet hole plate in the first direction, a flow channel plate which has a manifold communicated in a lump with the plurality of communication channels, and which is arranged at one side in a third direction crossing the second direction when viewed from the first direction with respect to the ejection section, and a protective film formed throughout the inner surfaces of the jet channels and inner surfaces of the communication channels, wherein the communication channels each include an upstream opening communicated with a channel opening which opens toward the first side in the first direction in the jet channel, a downstream opening communicated with a manifold opening which opens toward the first side in the first direction in the manifold, and a connecting part which extends in the third direction, and which is configured to connect the upstream opening and the downstream opening to each other, and the return plate is bonded to the ejection section so that at least a part of an opening edge in the upstream opening is arranged at an outer side when viewed from the first direction with respect to an opening edge of the channel opening.

According to the present aspect, since at least a part of the opening edge in the upstream opening is arranged at the outer side when viewed from the first direction with respect to the opening edge of the channel opening of the jet channel, it is possible to prevent the part (the flared part) flared at the inner side of the channel opening edge of the jet channel out of the opening edge of the upstream opening from being formed. Therefore, it is possible to prevent the liquid from being retained between the channel opening edge of the jet channel and the flared part. Therefore, it is possible to prevent disappearance of the protective films due to the retention of the liquid. Therefore, it is possible to provide the head chip excellent in durability.

(2) In the head chip according to the aspect (1) described above, it is preferable that the opening edge of the upstream opening includes a first upstream edge part located at the one side in the third direction, the opening edge of the channel opening includes a first channel edge part located at the one side in the third direction, and the first upstream edge part is located at the one side in the third direction when viewed from the first direction with respect to the first channel edge part.

A boundary portion between the first upstream edge part and the first channel edge part forms an inner corner portion when the liquid flows into the connecting part from the upstream opening part. When the flared part is provided to the inner corner portion, the retention of the liquid is apt to occur.

In contrast, in the present aspect, it is possible to prevent the first upstream edge part from flaring toward the other side in the third direction with respect to the first channel edge part. Therefore, it is possible to prevent the retention of the liquid in the inner corner portion.

(3) In the head chip according to the aspect (2) described above, it is preferable that the first upstream edge part increases in dimension in the first direction in a direction toward the one side in the third direction.

According to the present aspect, it is possible to make the inner corner portion formed between the first upstream edge part and the first channel edge part gentle, and thus, it is possible to make the flow of the liquid passing through the inner corner portion smooth. Thus, it is possible to prevent the retention of the liquid in the inner corner portion.

(4) In the head chip according to one of the aspects (2) and (3) described above, it is preferable that a distance in the third direction between the first upstream edge part and the first channel edge part is longer than a dimension in the first direction in the upstream opening.

According to the present aspect, since it is possible to make the first upstream edge part sufficiently distant from the first channel edge part, it is possible to prevent the retention of the liquid in the inner corner portion.

(5) In the head chip according to any of the aspects (2) through (4) described above, it is preferable that the opening edge of the upstream opening includes a second upstream edge part located at another side in the third direction, the opening edge of the channel opening includes a second channel edge part located at the other side in the third direction, and the second upstream edge part is located at the other side in the third direction when viewed from the first direction with respect to the second channel edge part.

According to the present aspect, it is possible to prevent the second upstream edge part from flaring toward the one side in the third direction with respect to the second channel edge part. Therefore, it is possible to prevent the retention of a bubble in an outer corner portion.

(6) In the head chip according to the aspect (5) described above, it is preferable that a distance in the third direction between the first upstream edge part and the first channel edge part is longer compared to a distance in the third direction between the second upstream edge part and the second channel edge part.

Since the liquid enters the connection part from the upstream opening around the inner corner portion, the liquid is more apt to be retained in the inner corner portion than in the outer corner portion. Therefore, in the present aspect, by making the distance in the third direction between the first upstream edge part and the first channel edge part longer compared to the distance in the third direction between the second upstream edge part and the second channel edge part, it is possible to more surely prevent the retention of the liquid in the inner corner portion.

(7) In the head chip according to any of the aspects (1) through (6) described above, it is preferable that the electrodes are formed on inner side surfaces facing each other in the second direction out of the inner surfaces of the jet channels, and a dimension in the second direction in the opening edge of the upstream opening is smaller than a dimension in the second direction in the opening edge of the channel opening.

According to the present aspect, the return plate and the ejection section are overlapped with each other so that the upstream opening fits into the inside in the second direction with respect to the channel opening. Thus, it is possible to suppress a variation in communication area between the upstream openings and the channel openings due to a processing accuracy and so on compared to when setting the dimension in the second direction in the upstream opening to be equivalent to the dimension in the second direction in the channel opening. Further, it is possible to prevent the laser beam having penetrated the return plate from reaching the electrode when providing the communication channels to the return plate using the laser processing or the like after bonding the return plate to the ejection section. Therefore, it is possible to provide the head chip high in quality.

(8) A liquid jet head according to an aspect of the present disclosure includes the head chip according to any one of the aspects (1) through (7) described above.

According to the present aspect, it is possible to provide a liquid jet head excellent in durability.

(9) A liquid jet recording device according to an aspect of the present disclosure includes the liquid jet head according to the aspect (8) described above.

According to the present aspect, it is possible to provide a liquid jet recording device excellent in durability.

According to an aspect of the present disclosure, it is possible to smoothly circulate ink between pressure chambers and a circulation channel.

### BRIEF DESCRIPTION OF THE DRAWINGS

FIG. 1 is a schematic configuration diagram of a printer according to a first embodiment.

FIG. 2 is a schematic configuration diagram of an inkjet head and an ink circulation mechanism according to the first embodiment.

FIG. 3 is an exploded perspective view of a head chip according to the first embodiment.

FIG. 4 is a cross-sectional view along the line IV-IV shown in FIG. 3.

FIG. 5 is a cross-sectional view along the line V-V shown in FIG. 3.

FIG. 6 is a cross-sectional view corresponding to the line VI-VI shown in FIG. 4.

FIG. 7 is an enlarged view of the VII portion shown in FIG. 4.

FIG. 8 is a cross-sectional view corresponding to the line VIII-VIII shown in FIG. 6.

FIG. 9 is a cross-sectional view corresponding to the line IX-IX shown in FIG. 6.

FIG. 10 is a cross-sectional view corresponding to the line X-X shown in FIG. 4.

FIG. 11 is a flowchart for explaining a method of manufacturing the head chip according to the first embodiment.

FIG. 12 is a process diagram for explaining the method of manufacturing the head chip according to the first embodiment.

FIG. 13 is a process diagram for explaining the method of manufacturing the head chip according to the first embodiment.

FIG. 14 is a process diagram for explaining the method of manufacturing the head chip according to the first embodiment.

FIG. 15 is a process diagram for explaining the method of manufacturing the head chip according to the first embodiment.

FIG. 16 is a cross-sectional view corresponding to FIG. 7 related to another configuration of the first embodiment.

FIG. 17 is a cross-sectional view corresponding to FIG. 7 related to a second embodiment.

FIG. 18 is a cross-sectional view corresponding to FIG. 7 related to another configuration of the second embodiment.

FIG. 19 is a cross-sectional view corresponding to FIG. 7, and related to a conventional head chip.

### DETAILED DESCRIPTION OF THE PREFERRED EMBODIMENTS

An embodiment according to the present disclosure will hereinafter be described with reference to the drawings. In the embodiments and modified examples hereinafter described, constituents corresponding to each other are denoted by the same reference symbols, and the description thereof will be omitted in some cases. In the following description, expressions representing relative or absolute arrangements such as “parallel,” “perpendicular,” “center,” and “coaxial” not only represent strictly such arrangements, but also represent the state of being relatively displaced with a tolerance, or an angle or a distance to the extent that the same function can be obtained. In the following embodiments, the description will be presented citing an inkjet printer (hereinafter simply referred to as a printer) for performing recording on a recording target medium using ink (a liquid) as an example. The scale size of each member is arbitrarily modified so as to provide a recognizable size to the member in the drawings used in the following description.

### First Embodiment

### [Printer 1]

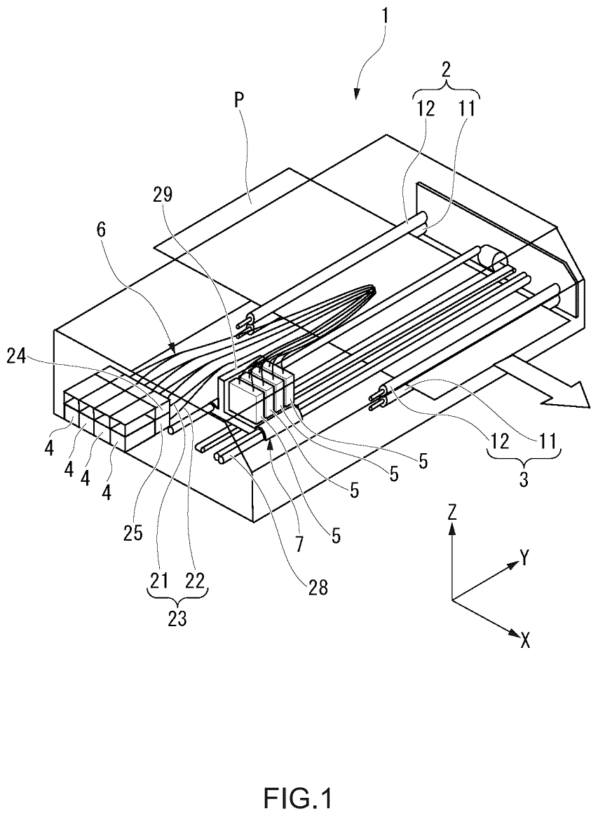

FIG. 1 is a schematic configuration diagram of a printer 1.

As shown in FIG. 1, the printer (a liquid jet recording device) 1 according to the first embodiment is provided with a pair of conveying mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, an X direction coincides with a conveying direction (a sub-scanning direction) of a recording target medium P (e.g., paper). A Y direction coincides with a scanning direction (a main scanning direction) of the scanning mechanism 7. A Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the first embodiment, the +Z side corresponds to an upper side in the gravitational direction, and the −Z side corresponds to a lower side in the gravitational direction.

The conveying mechanisms 2, 3 convey the recording target medium P toward the +X side. The conveying mechanisms 2, 3 each include a pair of rollers 11, 12 extending in, for example, the Y direction.

The ink tanks 4 respectively contain ink of four colors such as yellow, magenta, cyan, and black. The inkjet heads 5 are configured so as to be able to respectively eject the four colors of ink, namely the yellow ink, the magenta ink, the cyan ink, and the black ink according to the ink tanks 4 coupled thereto. It should be noted that water-based ink (electrically-conductive ink) using water as a solvent can be used as the ink contained in the ink tanks 4.

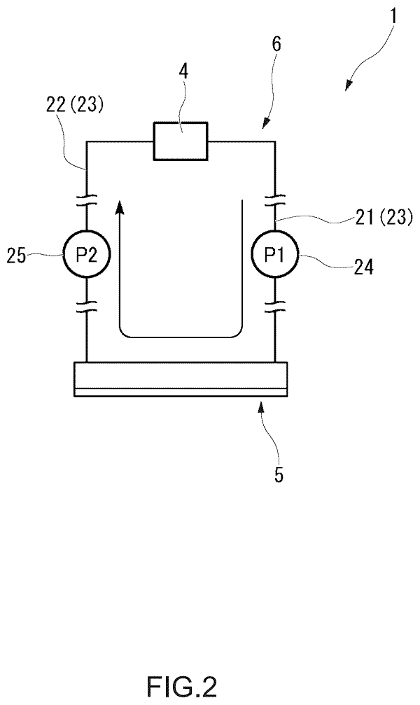

FIG. 2 is a schematic configuration diagram of the inkjet head 5 and the ink circulation mechanism 6.

As shown in FIG. 1 and FIG. 2, the ink circulation mechanism 6 circulates the ink between the ink tank 4 and the inkjet head 5. Specifically, the ink circulation mechanism 6 is provided with a circulation flow channel 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 is provided with negative pressure with respect to the inkjet head 5. It is arranged that the ink can circulate between the inkjet head 5 and the ink tank 4 through the circulation flow channel 23 by driving the pressure pump 24 and the suction pump 25.

The scanning mechanism 7 makes the inkjet heads 5 perform a reciprocal scan in the Y direction. The scanning mechanism 7 is provided with a guide rail 28 extending in the Y direction, and a carriage 29 movably supported by the guide rail 28.

### <Inkjet Heads 5>

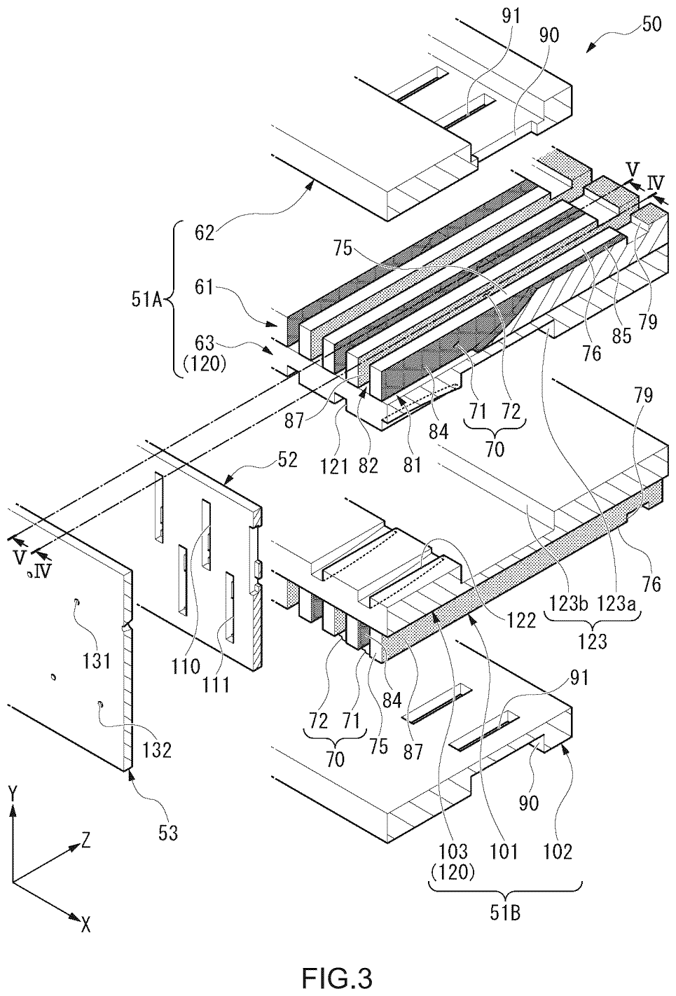

As shown in FIG. 1, the inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply section (not shown) for coupling the ink circulation mechanism 6 and the head chip 50, and a control section (not shown) for applying a drive voltage to the head chip 50.

### <Head Chip 50>

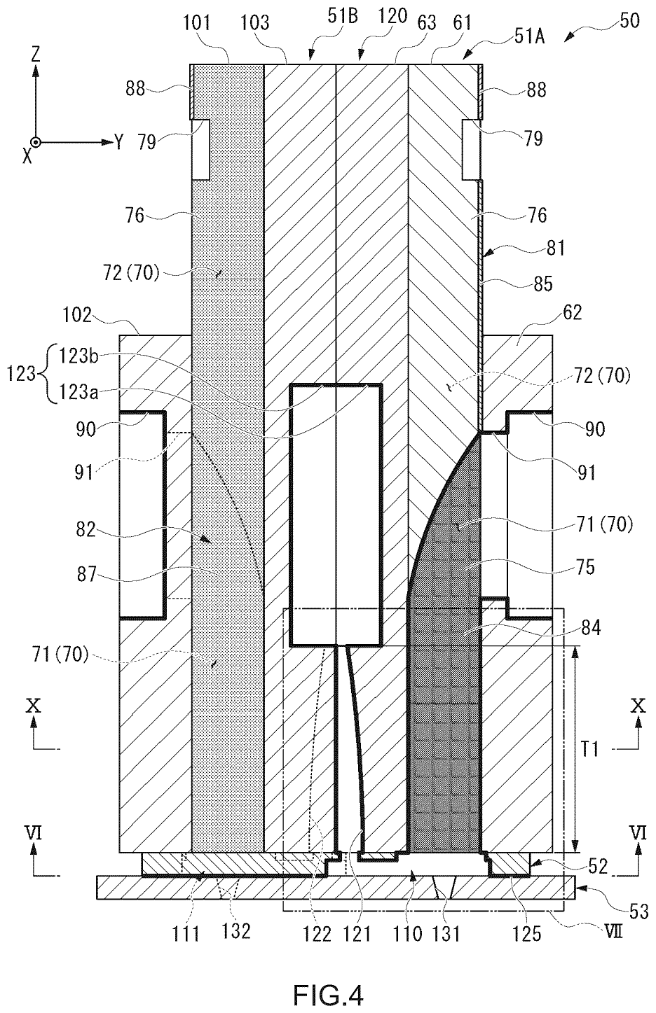

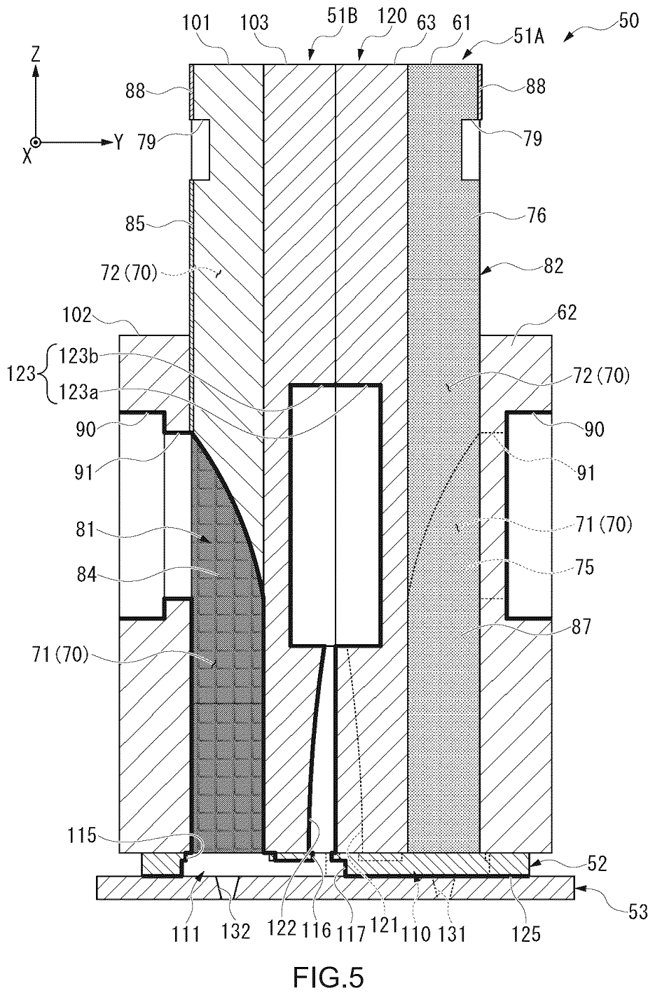

FIG. 3 is an exploded perspective view of the head chip 50. FIG. 4 is a cross-sectional view along the line IV-IV shown in FIG. 3. FIG. 5 is a cross-sectional view along the line V-V shown in FIG. 3.

As shown in FIG. 3 through FIG. 5, the head chip 50 is of a circulation type (a vertical circulation type) which circulates the ink with the ink tank 4 out of so-called edge-shoot types which eject the ink from a tip portion in a channel extension direction (the Z direction) in each of ejection channels 71 described later.

The head chip 50 is provided with a first chip module 51A, a second chip module 51B, a return plate 52, and a nozzle plate (a jet hole plate) 53. In the following explanation, a configuration of each of the chip modules 51A, 51B will be described citing the first chip module 51A as an example. Therefore, the constituents in the second chip module 51B substantially the same as those of the first chip module 51A are denoted by the same reference symbols as in the first chip module 51A, and the description thereof will be omitted in some cases.

### <First Chip Module 51A>

The first chip module 51A is provided with a first actuator plate 61, a first cover plate 62, and a first back plate 63. In the following explanation, the first chip module 51A will be described defining the +Y side as an obverse surface side, and the −Y side as a reverse surface side. It should be noted that the first ejection section is constituted by the first actuator plate 61 and the first cover plate 62.

The first actuator plate 61 is formed of a laminated substrate (a so-called chevron type) having two piezoelectric substrates which are different in polarization direction along the thickness direction (the Y direction) from each other, and are stacked on one another. It should be noted that as the piezoelectric substrates, there is preferably used a ceramics substrate formed of, for example, PZT (lead zirconate titanate). It should be noted that the first actuator plate 61 can be formed of a single piezoelectric substrate in which the polarization direction is set in a single direction (a so-called monopole type).

The first actuator plate 61 is provided with the ejection channels (first jet channels, jet channels) 71 each filled with the ink, and non-ejection channels 72 not filled with the ink. The channels 71, 72 are alternately arranged at intervals in the X direction (a second direction) in the first actuator plate 61 to thereby form a channel array 70. The configuration in which the channel extension direction coincides with the Z direction (a first direction) will be described in the present embodiment, but the channel extension direction can cross the Z direction.

As shown in FIG. 3 and FIG. 4, the ejection channels 71 each have an upper end portion terminating within the first actuator plate 61, and a lower end portion opening on a lower end surface of the first actuator plate 61. An upper part of each of the ejection channels 71 gradually shallows in depth in the Y direction along the upward direction. In contrast, a lower part of each of the ejection channels 71 penetrates the first actuator plate 61 in the Y direction.

As shown in FIG. 3 and FIG. 5, the non-ejection channels 72 penetrate the first actuator plate 61 in the Y direction, and at the same time penetrate the first actuator plate 61 in the Z direction. The depth in the Y direction in the non-ejection channels 72 is uniform throughout the entire length in the Z direction.

In the first actuator plate 61, a portion located between each of the ejection channels 71 and corresponding one of the non-ejection channels 72 constitutes a drive wall 75. Therefore, both sides in the X direction of the ejection channel 71 are surrounded by the pair of drive walls 75. In the first actuator plate 61, a portion located above the ejection channel 71 constitutes a tail part 76.

As shown in FIG. 3, the first actuator plate 61 is provided with common wiring lines 81 and individual wiring lines 82. Each of the wiring lines 81, 82 is formed by depositing an electrode material such as Ti/Au or Ni/Au using, for example, evaporation, sputtering, or plating.

As shown in FIG. 3 and FIG. 4, the common wiring lines 81 are each provided with a common electrode 84 and a common terminal 85.

The common electrode 84 is formed on inner side surfaces opposed to each other in the X direction out of the inner surfaces of the ejection channel 71. In the illustrated example, the common electrode 84 is formed throughout the entire area in the Y direction on the inner side surfaces of the ejection channel 71.

The common terminal 85 is formed on an obverse surface of the tail part 76. The common terminal 85 is disposed on the obverse surface of the tail part 76 so as to correspond to each of the ejection channels 71. Each of the common terminals 85 extends linearly in the Z direction above corresponding one of the ejection channels 71. A lower end portion in the common terminal 85 is connected to the common electrode 84.

As shown in FIG. 3 and FIG. 5, the individual wiring lines 82 are each provided with individual electrodes 87, and an individual terminal 88.

The individual electrodes 87 are each formed on one of the inner side surfaces opposed to each other in the X direction out of the inner surfaces of each of the non-ejection channels 72. In the illustrated example, the individual electrode 87 is formed throughout the entire area in the Y direction on the inner side surface of the non-ejection channel 72.

The individual terminal 88 is provided to a portion located above the common terminal 85 on the obverse surface of the tail part 76. The individual terminal 88 is formed to have a strip-like shape extending in the X direction. The individual terminal 88 connects the individual electrodes 87, which are opposed to each other in the X direction across the ejection channel 71, to each other at obverse surface side opening edges of the non-ejection channels 72 which are opposed to each other in the X direction across the ejection channel 71. In the tail part 76, a portion located between the common terminal 85 and the individual terminal 88 is provided with a partitioning groove 79. The partitioning groove 79 extends in the X direction in the tail part 76. The partitioning groove 79 separates the common terminal 85 and the individual terminal 88 from each other.

To the obverse surface of the tail part 76, there is pressure-bonded a flexible printed board (not shown). The flexible printed board is coupled to the common terminals 85 and the individual terminals 88 on the obverse surfaces of the tail parts 76. The flexible printed board couples the first chip module 51A and the control section to each other.

### <First Cover Plate 62>

As shown in FIG. 3 through FIG. 5, the first cover plate 62 is bonded to the obverse surface of the first actuator plate 61. Specifically, the first cover plate 62 closes the obverse surface-side openings of the channels 71, 72 in a state of exposing the obverse surfaces of the tail parts 76. A lower end surface of the first cover plate 62 is arranged so as to be coplanar with the lower end surface of the first actuator plate 61.

In the first cover plate 62, at positions overlapping the upper parts of the ejection channels 71 when viewed from the Y direction, there is formed a common ink chamber 90. The common ink chamber 90 extends in the X direction with a length sufficient for straddling, for example, the channel array 70, and at the same time, opens on the obverse surface of the first cover plate 62. The common ink chamber 90 is indirectly connected to the ink supply tube 21 through an entrance port not shown.

In the common ink chamber 90, at the positions overlapping the respective ejection channels 71 viewed from the Y direction, there are formed slits 91. The slits 91 each communicate the upper part of corresponding one of the ejection channels 71 and the inside of the common ink chamber 90 with each other. Therefore, the common ink chamber 90 is communicated with the ejection channels 71 through the respective slits 90 on the one hand, but is not communicated with the non-ejection channels 72 on the other hand.

### <First Back Plate 63>

The first back plate 63 is bonded to a reverse surface of the first actuator plate 61. The first back plate 63 has an equivalent outer shape to that of the first actuator plate 61 when viewed from the Y direction. The first back plate 63 is overlapped with the whole of the first actuator plate 61 when viewed from the Y direction. In other words, the first back plate 63 closes reverse surface side openings of the channels 71, 72.

### <Second Chip Module 51B>

The second chip module 51B is provided with a second actuator plate 101, a second cover plate 102, and a second back plate (a flow channel plate) 103. The second chip module 51B has the second back plate 103, the second actuator plate 101, and the second cover plate 102 overlapped in sequence from the +Y side toward the −Y side. The second chip module 51B is overlapped with the first chip module 51A in a state in which the obverse surface side (the −Y side) faces to an opposite side to the first chip module 51A. Specifically, the first chip module 51A and the second chip module 51B are integrated with each other by the reverse surfaces of the first back plate 63 and the second back plate 103 being bonded to each other. In this case, the lower end surfaces of the respective chip modules 51A, 51B are arranged so as to be coplanar with each other. It should be noted that the second ejection section is constituted by the second actuator plate 101 and the second cover plate 102.

The ejection channels (second jet channels) 71 and the non-ejection channels 72 of the second chip module 51B are arranged so as to be shifted as much as a half pitch with respect to the arrangement pitch of the ejection channels 71 and the non-ejection channels 72 of the first chip module 51A. In other words, the ejection channels 71 of the chip modules 51A, 51B, and the non-ejection channels 72 of the chip modules 51A, 51B are each arranged in a zigzag manner. In this case, the ejection channels 71 of the first chip module 51A and the non-ejection channels 72 of the second chip module 51B face each other in the Y direction, and the non-ejection channels 72 of the first chip module 51A and the ejection channels 71 of the second chip module 51B face each other in the Y direction. It should be noted that the pitch of the channels 71, 72 in each of the chip modules 51A, 51B can arbitrarily be changed.

### <Return Plate 52>

The return plate 52 is bonded to the lower end surfaces of the respective chip modules 51A, 51B in a lump via an adhesive. The return plate 52 closes the lower end opening parts of the respective channels 71, 72. The return plate 52 is formed of, for example, polyimide. The return plate 52 is provided with a plurality of first communication channels 110 and a plurality of second communication channels 111.

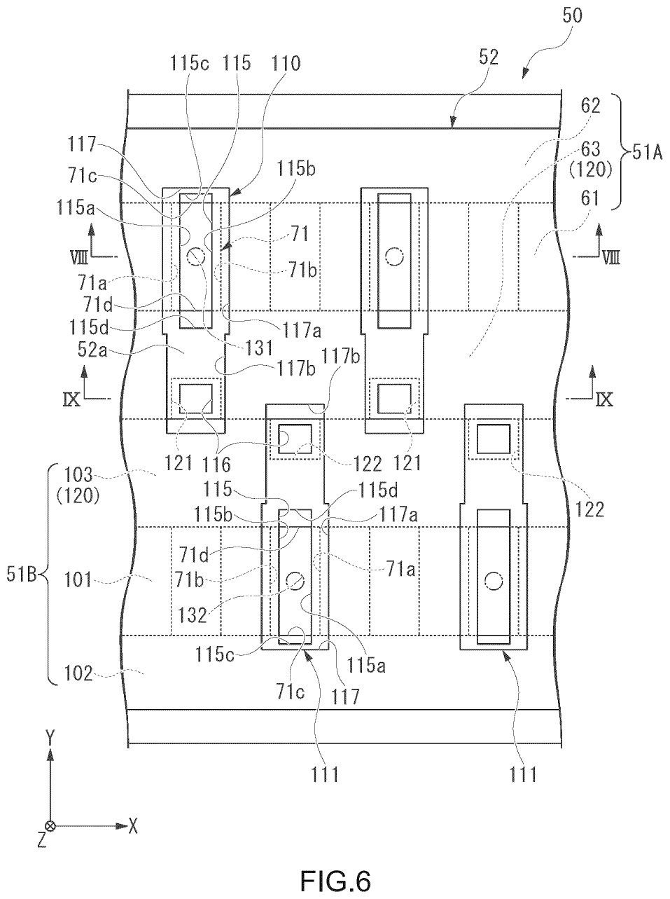

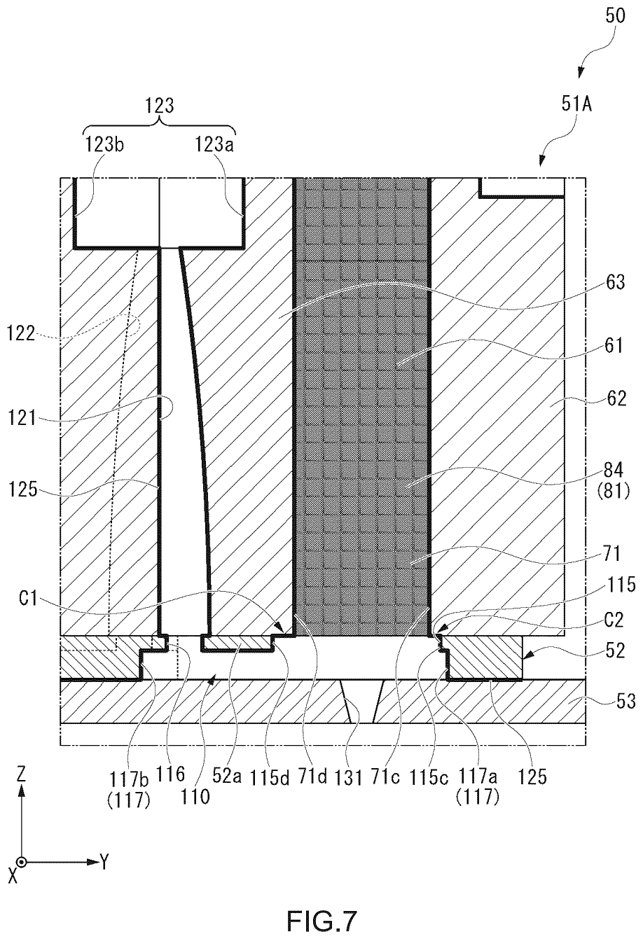

FIG. 6 is a cross-sectional view corresponding to the line VI-VI shown in FIG. 4. FIG. 7 is an enlarged view of the VII portion shown in FIG. 4.

As shown in FIG. 6 and FIG. 7, the plurality of first communication channels 110 is formed individually at equivalent positions in the X direction to those of the respective ejection channels 71 in the first chip module 51A. In the present embodiment, the plurality of first communication channels 110 is formed at intervals in the X direction so as to correspond to the arrangement pitch of the ejection channels 71. Each of the first communication channels 110 is formed to have a U-shape in a side view viewed from the X direction. Specifically, each of the first communication channels 110 is provided with an upstream opening 115, a downstream opening 116, and a connecting part 117. Since the first communication channels 110 have substantially the same configurations, in the following configuration, the details of the first communication channels 110 will be described citing one of the first communication channels 110 as an example.

The upstream opening 115 is formed at a position overlapping the ejection channel 71 when viewed from the Z direction. The upstream opening 115 has an upper end portion opening on an upper surface of the return plate 52, and a lower end portion terminating in the return plate 52. The upstream opening 115 is communicated with the lower end opening (a channel opening) of the ejection channel 71. In the present embodiment, the flow channel cross-sectional area (the cross-sectional area perpendicular to the Z direction) of the upstream opening 115 is uniform throughout the entire length in the Z direction. It should be noted that the flow channel cross-sectional area of the upstream opening 115 can change in accordance with a position in the Z direction.

At least a part of an opening edge of the upstream opening 115 is arranged at an outer side of a lower end opening edge of the ejection channel 71 when viewed from the Z direction. Specifically, a dimension in the X direction in the upstream opening 115 is smaller than a dimension in the X direction in the lower end opening of the ejection channel 71. A dimension in the Y direction in the upstream opening 115 is larger than a dimension in the Y direction in the lower end opening of the ejection channel 71.

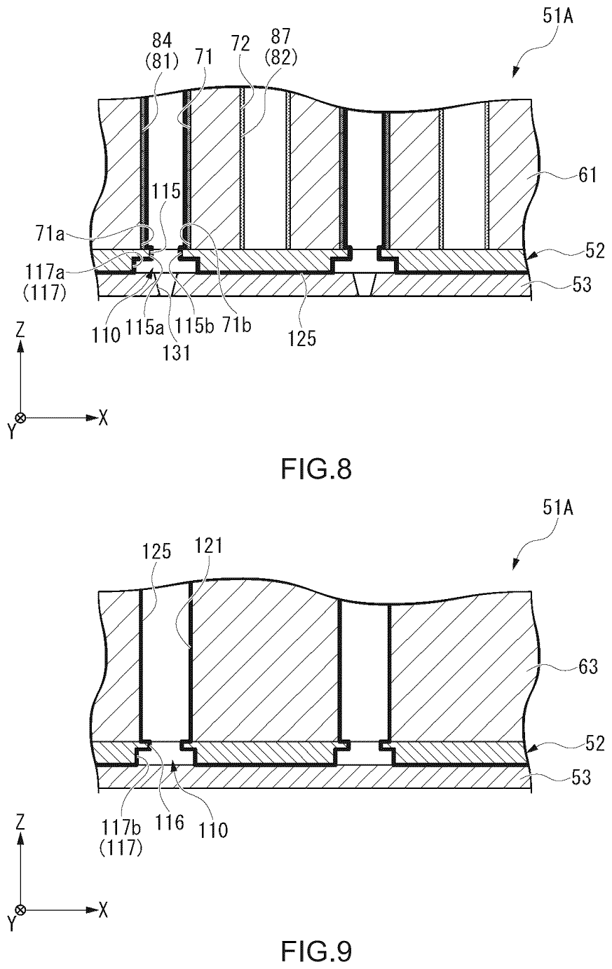

FIG. 8 is a cross-sectional view corresponding to the line VIII-VIII shown in FIG. 6.

Here, as shown in FIG. 6 through FIG. 8, the lower end opening edge of the ejection channel 71 is provided with a pair of channel side edge parts 71a, 71b opposed to each other in the X direction, a channel back edge part 71c which connects the pair of channel side edge parts 71a, 71b to each other, and a channel front edge part 71d which connects −Y-side end parts in the pair of channel side edge parts 71a, 71b to each other. Further, the opening edge of the upstream opening 115 is provided with a pair of upstream side edge parts 115a, 115b opposed to each other in the X direction, an upstream back edge part 115c which connects +Y-side end parts of the pair of upstream edge parts 115a, 115b to each other, and an upstream front edge part 115d which connects −Y-side end parts in the pair of upstream side edge parts 115a, 115b to each other.

As shown in FIG. 6 and FIG. 8, the upstream side edge part 115a linearly extends in the Y direction at an inner side (the +X side) in the X direction of the channel side edge part 71a.

The upstream side edge part 115b linearly extends in the Y direction at an inner side (the −X side) in the X direction of the channel-side edge part 71b.

As shown in FIG. 6 and FIG. 7, the upstream back edge part 115c linearly extends in the X direction at an outer side (the +Y side) in the Y direction of the channel back edge part 71c.

The upstream front edge part 115d linearly extends in the X direction at an outer side (the −Y side) in the Y direction of the channel front edge part 71d.

As described above, the upstream back edge part 115c and the upstream front edge part 115d are arranged at the outer side of the lower end opening edge (the channel back edge part 71c and the channel front edge part 71d) of the ejection channel 71 when viewed from the Z direction. Therefore, in the lower end surface of the first chip module 51A, portions located at both sides in the Y direction with respect to the ejection channel 71 are exposed through the upstream opening 115. It is preferable for an amount of retraction in the Y direction of the upstream front edge part 115d with respect to the channel front edge part 71d to be larger than an amount of retraction in the Y direction of the upstream back edge part 115c with respect to the channel back edge part 71c. In the present embodiment, it is preferable for the amount of retraction of the upstream back edge part 115c to be as small as possible, for example, no larger than 30 μm.

FIG. 9 is a cross-sectional view corresponding to the line IX-IX shown in FIG. 6.

As shown in FIG. 6, FIG. 7, and FIG. 9, the downstream opening 116 is formed at a position overlapping the ejection channel 71 when viewed from the Z direction. The downstream opening 116 has an upper end portion opening on the upper surface of the return plate 52, and a lower end portion terminating in the return plate 52. A dimension in the Z direction in the downstream opening 116 is made equivalent to that of the upstream opening 115. In the present embodiment, the flow channel cross-sectional area (the cross-sectional area perpendicular to the Z direction) of the downstream opening 116 is uniform throughout the entire length in the Z direction. It should be noted that the flow channel cross-sectional area of the downstream opening 116 can change in accordance with a position in the Z direction.

The flow channel cross-sectional area of the downstream opening 116 is smaller than the flow channel cross-sectional area of the upstream opening 115. In the illustrated example, the downstream opening 116 is made equivalent in the dimension in the X direction to the upstream opening 115, and is made smaller in the dimension in the Y direction than the upstream opening 115. It should be noted that the flow channel cross-sectional area of the downstream opening 116 can be no smaller than the flow channel cross-sectional area of the upstream opening 115.

The connecting part 117 communicates the upstream opening 115 and the downstream opening 116 with each other. The connecting part 117 opens on the lower surface of the return part 52, and at the same time, extends in the Y direction. A dimension in the Z direction in the connecting part 117 is made uniform throughout the entire length in the Y direction. In the present embodiment, the dimension in the Z direction in the connecting part 117 is larger than the dimensions in the Z direction in the upstream opening 115 and the downstream opening 116. It should be noted that the dimension in the Z direction in the connecting part 117 can be made different in accordance with a position in the Y direction.

The connecting part 117 is larger in dimension in the X direction than the upstream opening 115 and the downstream opening 116 when viewed from the Z direction. Specifically, the connecting part 117 is provided with an upstream wide part 117a and a downstream wide part 117b.

The upstream wide part 117a is arranged at a position overlapping the upstream opening 115 when viewed from the Z direction. The upstream wide part 117a is made one size larger than the upstream opening 115 when viewed from the Z direction.

The downstream wide part 117b extends toward the −Y side from the upstream wide part 117a. The downstream wide part 117b overlaps the downstream opening 116 when viewed from the Z direction. The downstream wide part 117b is made one size larger than the downstream opening 116 when viewed from the Z direction. A dimension in the X direction in the downstream wide part 117b is made smaller than that of the upstream wide part 117a.

In the return plate 52, a portion surrounded by the first communication channel 110 when viewed from the X direction constitutes an end surface covering part 52a. The end surface covering part 52a covers a lower end surface of the first back plate 63 in a state of being bonded to the lower end surface of the first back plate 63 via an adhesive. Specifically, an end surface facing to the +Y side in the end surface covering part 52a constitutes the upstream front edge part 115d. In other words, an end surface facing to the +Y side in the end surface covering part 52a is located at an outer side in the Y direction of the channel front edge part 71d, and at the same time, linearly extends in the Z direction.

As shown in FIG. 5, the plurality of second communication channels 111 is formed individually at equivalent positions in the X direction to those of the respective ejection channels 71 in the second chip module 51B. In the present embodiment, the plurality of second communication channels 111 is formed at intervals in the X direction so as to correspond to the arrangement pitch of the ejection channels 71 of the second chip module 51B. Specifically, the first communication channels 110 and the second communication channels 111 are alternately arranged at intervals in the X direction. It should be noted that the second communication channels 111 have substantially the same configuration as that of the first communication channels 110. Therefore, substantially the same constituents of the second communication channels 111 as those of the first communication channels 110 are denoted by the same reference symbols to omit the detailed description of the second communication channels 111.

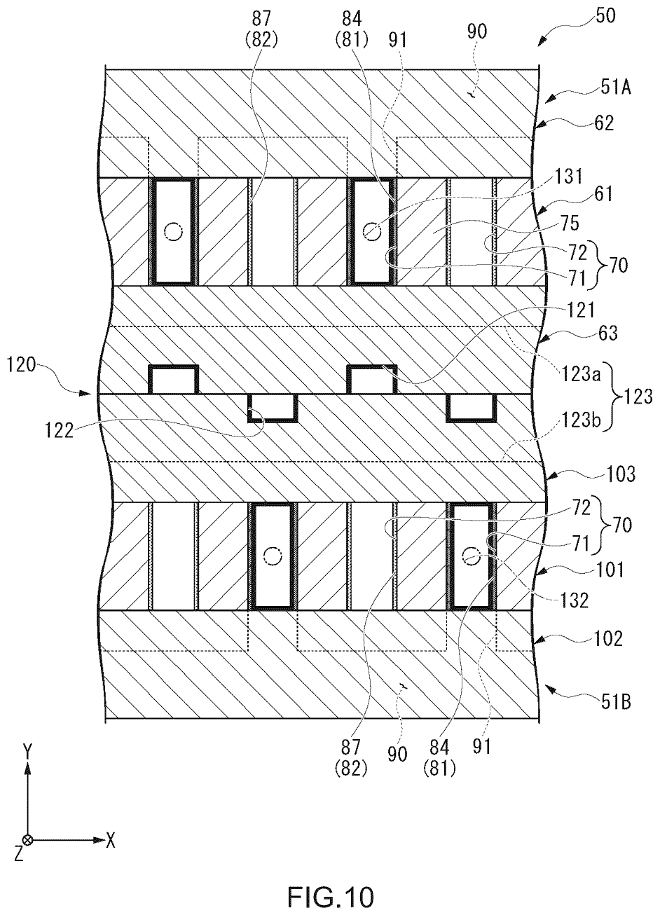

FIG. 10 is a cross-sectional view corresponding to the line X-X shown in FIG. 4.

As shown in FIG. 4, FIG. 5, FIG. 6, and FIG. 10, the first back plate 63 and the second back plate 103 described above constitute a flow channel plate 120 in the present embodiment. The flow channel plate 120 is provided with a plurality of first connecting channels 121, a plurality of second connecting channels 122, and a manifold 123.

The plurality of first connecting channels 121 is formed individually at positions overlapping the downstream openings 116 of the respective first communication channels 110 when viewed from the Z direction. The first connecting channels 121 are arranged at intervals in the X direction at the same pitch as that of the first communication channels 110. Specifically, the first connecting channels 121 open on the reverse surface of the first back plate 63. The reverse surface side openings in the first connecting channels 121 are closed by the second back plate 103.

The first connecting channels 121 each extend linearly in the Z direction when viewed from the Y direction. A lower end part in each of the first connecting channels 121 opens on the lower end surface of the first back plate 63. Thus, the lower end opening of each of the first connecting channels 121 is communicated with the downstream opening 116. In contrast, an upper end part in each of the first connecting channels 121 terminates in the first back plate 63.

As shown in FIG. 7 and FIG. 9, the lower end opening of each of the first connecting channels 121 is made larger in dimension in the X direction than the downstream opening 116, and is made smaller in dimension in the X direction than the downstream wide part 117b. In this case, an opening edge of the downstream opening 116 flares to the inside of the lower end opening edge of the first connecting channel 121. It should be noted that it is possible for the lower end opening in each of the first connecting channels 121 to be made larger in dimension in the X direction than the downstream wide part 117b, or made smaller in dimension in the X direction than the downstream opening 116.

As shown in FIG. 4 and FIG. 5, each of the first connecting channels 121 gradually decreases in flow channel cross-sectional area (the cross-sectional area perpendicular to the Z direction) in a direction from the lower end opening toward the upper end opening. Specifically, in each of the first connecting channels 121, the dimension in the Y direction gradually decreases in a direction from below to above. It should be noted that, in each of the first connecting channels 121, it is possible for the dimension in the X direction to gradually decrease in the direction from below to above. Further, it is possible for the flow channel cross-sectional area of each of the first connecting channels 121 to be uniform throughout the entire length in the Z direction.

As shown in FIG. 10, the plurality of second connecting channels 122 is formed individually at positions overlapping the downstream openings 116 of the respective second communication channels 111 when viewed from the Z direction. The second connecting channels 122 are arranged at intervals in the X direction at the same pitch as that of the second communication channels 111. Specifically, the first communication channels 121 and the second communication channels 122 are alternately arranged in the X direction.

As shown in FIG. 5 and FIG. 6, each of the second connecting channels 122 is communicated with the downstream opening 116 of corresponding one of the second communication channels 111. Specifically, the second connecting channels 122 open on the reverse surface (a surface facing to the +Y side) of the second back plate 103. The reverse surface side openings in the second connecting channels 122 are closed by the first back plate 63. The second connecting channels 122 extend in the Z direction. A lower end part in each of the second connecting channels 122 opens on the lower end surface of the second back plate 103. Thus, the lower end opening of each of the second connecting channels 122 is communicated with the downstream opening 116 of corresponding one of the second communication channels 111. In contrast, an upper end part in each of the second connecting channels 122 terminates in the second back plate 103. It should be noted that it is possible to set the dimensions and so on of the second connecting channels 122 to substantially the same as those of the first connecting channels 121.

The manifold 123 is provided to a portion located above the connecting channels 121, 122 in the flow channel plate 120. The manifold 123 is formed by overlapping a first recessed part 123a provided to the first back plate 63 and a second recessed part 123b provided to the second back plate 103 each other. The first recessed part 123a is a recessed part which opens on the reverse surface of the first back plate 63, and which extends in the Z direction and the Y direction. The second recessed part 123b is a recessed part which opens on the reverse surface of the second back plate 103, and which extends in the Z direction and the Y direction. The manifold 123 is formed by communicating the reverse surface side openings of the first recessed part 123a and the second recessed part 123b with each other. It should be noted that in the illustrated example, the dimensions of the first recessed part 123a and the second recessed part 123b are equivalent to each other. It should be noted that the first recessed part 123a and the second recessed part 123b can be made different in dimensions from each other. Further, the manifold 123 can be provided with a configuration in which a recessed part provided to either one of the first back plate 63 and the second back plate 103 is closed by the reverse surface of the other of the back plates.

The connecting channels 121, 122 are communicated in a lump with the manifold 123. Specifically, the upper end opening of each of the first connecting channels 121 opens on the lower end surface of the first recessed part 123a. An upper end opening of each of the second connecting channels 122 opens on the lower end surface of the second recessed part 123b. It should be noted that the manifold 123 is indirectly connected to the ink discharge tube 22 through an exit port not shown.

Here, the chip modules 51A, 51B and the return plate 52 are covered with protective films 125. In the present embodiment, the protective films 125 are also formed on an inner surface of the common ink chamber 90, inner surfaces of the slits 91, inner surfaces of the ejection channels 71, inner surfaces of the communication channels 110, 111, inner surfaces of the connecting channels 121, 122, and an inner surface of the manifold 123. The protective films 125 each include an organic insulating material such as a para-xylylene resin material (e.g., parylene (a registered trademark)) as a material having an insulating property. The protective films 125 can be formed of tantalum oxide (Ta₂O₅), silicon nitride (SiN), silicon carbide (SiC), silicon oxide (SiO₂), diamond-like carbon, or the like, or can include at least any one of these materials.

### <Nozzle Plate 53>

As shown in FIG. 3 through FIG. 5, the nozzle plate 53 is bonded to the lower end surface of the return plate 52. A plurality of nozzle holes (first nozzle holes 131 and second nozzle holes 132) each penetrating the nozzle plate 53 in the Z direction is arranged in the nozzle plate 53.

In the nozzle plate 53, the plurality of first nozzle holes (jet holes) 131 is formed individually at positions overlapping the respective first communication channels 110 when viewed from the Z direction. In other words, the first nozzle holes 131 are arranged at intervals in the X direction at the same pitch as that of the first communication channels 110. The first nozzle holes 131 are communicated with the corresponding ejection channels 71 of the first chip module 51A through the corresponding first communication channels 110, respectively. Specifically, the first nozzle holes 131 are each formed at a position overlapping the ejection channel 71 and the upstream wide part 117a when viewed from the Z direction in a +Y-side end part in corresponding one of the first communication channels 110. It should be noted that the first nozzle holes 131 can be communicated with the first communication channels 110 at positions shifted in the Y direction from the ejection channels 71 of the first chip module 51A, respectively.

In the nozzle plate 53, the plurality of second nozzle holes (jet holes) 132 is formed individually at positions overlapping the second communication channels 111 when viewed from the Z direction. In other words, the second nozzle holes 132 are arranged at intervals in the X direction at the same pitch as that of the second communication channels 111. The second nozzle holes 132 are communicated with the corresponding ejection channels 71 of the second chip module 51B through the corresponding second communication channels 111, respectively. Specifically, the second nozzle holes 132 are each formed at a position overlapping the ejection channel 71 and the upstream wide part 117a when viewed from the Z direction in a −Y-side end part in corresponding one of the second communication channels 111. It should be noted that the second nozzle holes 132 can be communicated with the second communication channels 111 at positions shifted in the Y direction from the ejection channels 71 of the second chip module 51B, respectively.

### [Operation Method of Printer 1]

Then, there will hereinafter be described a case when recording a character, a figure, or the like on the recording target medium P using the printer 1 configured as described above.

It should be noted that it is assumed that as an initial state, the sufficient ink having colors different from each other is respectively encapsulated in the four ink tanks 4 shown in FIG. 1. Further, there is provided a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12. By the carriage 29 moving in the Y direction at the same time as the conveyance of the recording target medium P, the inkjet heads 5 mounted on the carriage 29 reciprocate in the Y direction.

Here, the operation of each of the inkjet heads 5 will hereinafter be described in detail.

In such a vertically circulating type head chip 50 as in the present embodiment, first, by making the pressure pump 24 and the suction pump 25 shown in FIG. 2 operate, the ink is circulated in the circulation flow channel 23. In this case, the ink circulating through the ink supply tube 21 flows into the common ink chamber 90 of each of the chip modules 51 through the entrance port. The ink having flowed into the common ink chambers 90 is supplied to the inside of each of the ejection channels 71 through the slit 91. The ink having flowed into the ejection channels 71 gathers in the manifold 123 through the communication channels 110, 111 and the connecting channels 121, 122, and is then discharged to the ink discharge tube 22 through the exit port. The ink discharged to the ink discharge tube 22 is returned to the ink tank 4, and is then supplied again to the ink supply tube 21. Thus, the ink is circulated between the inkjet head 5 and the ink tank 4.

Then, when the reciprocation is started by the carriage 29, the drive voltages are applied to the electrodes 84, 87 via the flexible boards. On this occasion, the drive voltage is applied between the electrodes 84, 87 by setting the individual electrode 87 at a drive potential Vdd, and the common electrode 84 at a reference potential GND. Then, a thickness shear deformation occurs in the two drive walls 75 partitioning the ejection channel 75, and the two drive walls 75 each deform so as to protrude toward the non-ejection channel 72. Specifically, the actuator plates 61, 101 each have two piezoelectric substrates on which the polarization treatment has been performed in the thickness direction (the Y direction), and which are stacked on one another, and therefore, by applying the drive voltage, the actuator plates 61, 101 each make a flexural deformation having a V-shape centering on an intermediate position in the Y direction in the drive walls 75. Thus, the ejection channel 71 deforms as if it bulges.

When the volume of the ejection channel 71 increases due to the deformation of the two drive walls 75, the ink in the common ink chamber 90 is induced into the ejection channel 71 through the slit 91. Then, the ink induced to the inside of the ejection channel 71 propagates to the inside of the ejection channel 71 as a pressure wave, and the drive voltage applied between the electrodes 84, 87 is set to zero at the timing at which the pressure wave reaches the nozzle hole 131, 132.

Thus, the drive walls 75 are restored, and the volume of the ejection channel 71 having once increased is restored to the original volume. Due to this operation, the internal pressure of the ejection channel 71 increases to pressurize the ink. As a result, it is possible to eject the ink from the nozzle hole 131, 132. On this occasion, the ink turns to an ink droplet having a droplet shape when passing through the nozzle hole 131, 132, and is then ejected. Thus, it is possible to record a character, an image, or the like on the recording target medium P as described above. In other words, in the head chip 50 according to the present embodiment, out of the ink flowing through each of the communication channels 110, 111, a part is ejected through corresponding one of the nozzle holes 131, 132, while the rest is returned to the manifold 123 through corresponding one of the connecting channels 121, 122.

### [Method of Manufacturing Head Chip 50]

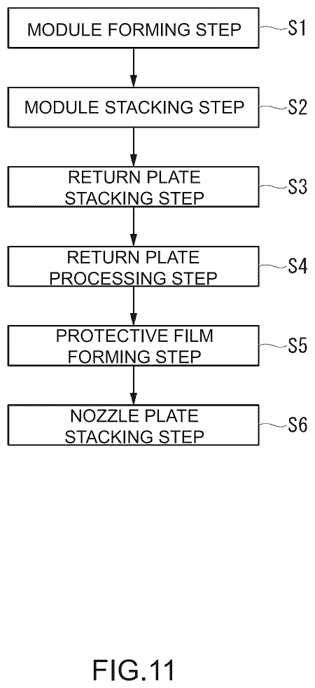

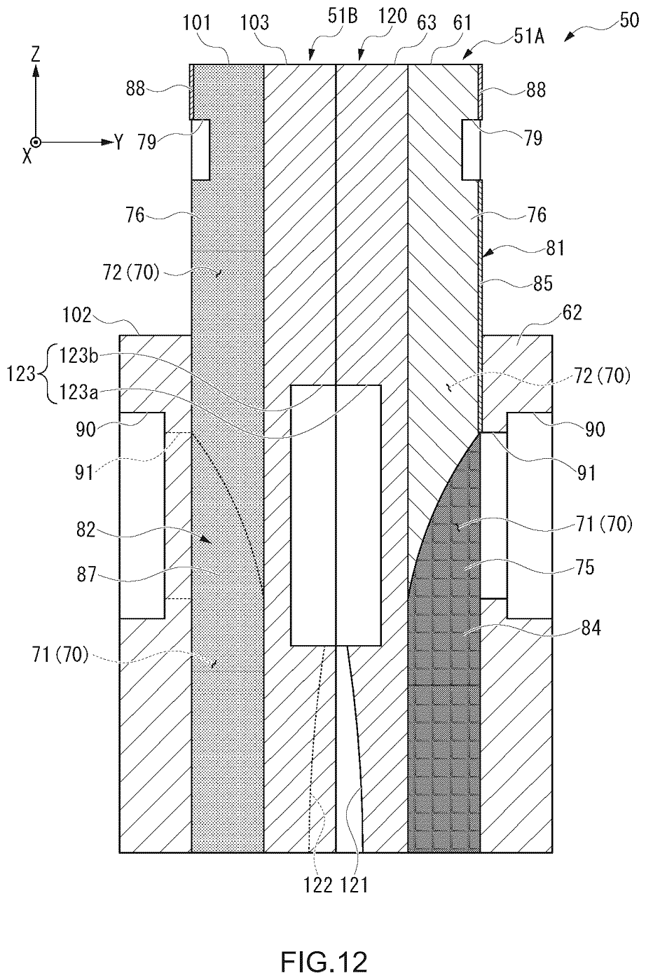

Then, a method of manufacturing the head chip 50 described above will be described. FIG. 11 is a flowchart for explaining the method of manufacturing the head chip 50. FIG. 12 through FIG. 15 are each a process diagram for explaining the method of manufacturing the head chip 50. In the following description, there is described a case when manufacturing the head chip 50 chip by chip as an example for the sake of convenience.

As shown in FIG. 11, the method of manufacturing the head chip 50 is provided with a module forming step S1, a module stacking step S2, a return plate stacking step S3, a return plate processing step S4, a protective film forming step S5, and a nozzle plate stacking step S6.

In the module forming step S1, each of the first chip module 51A and the second chip module 51B is formed.

As shown in FIG. 12, in the module stacking step S2, the chip modules 51A, 51B formed in the chip module forming step S1 are bonded to each other. Specifically, the reverse surfaces of the back plates 63, 103 are bonded to each other in a state in which the lower end surfaces of the respective chip modules 51A, 51B coincide with each other. Thus, the reverse side openings of the first connecting channels 121 are closed by the second back plate 103, the reverse side openings of the second connecting channels 122 are closed by the first back plate 63, and at the same time, the manifold 123 is formed with the first recessed part 123a and the second recessed part 123b. Thus, the stacked body of the chip modules 51A, 51B is formed.

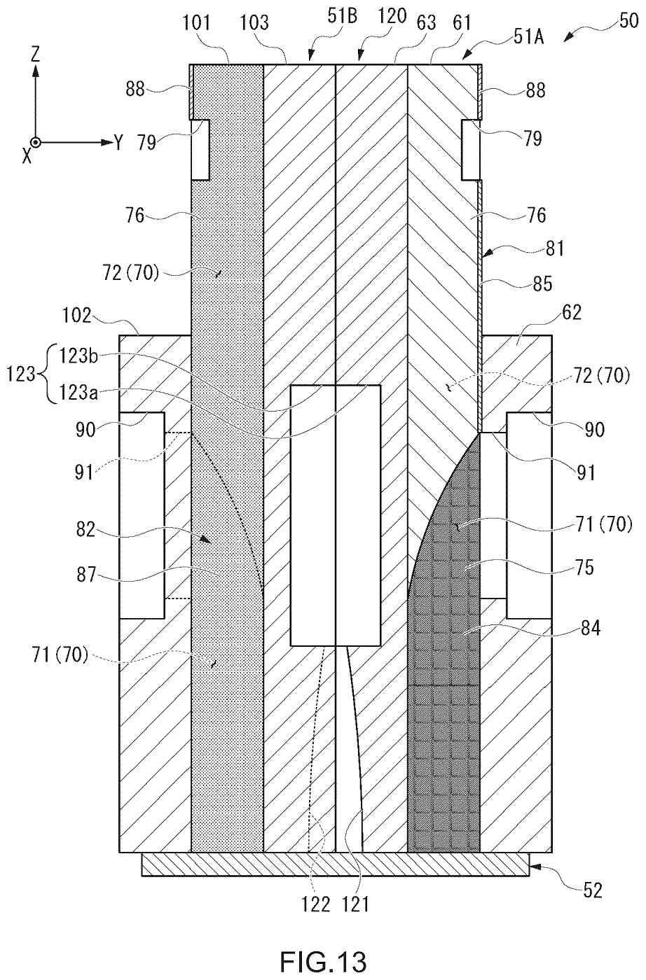

As shown in FIG. 13, in the return plate stacking step S3, the return plate 52 is bonded to a lower end surface in the stacked body of the chip modules 51A, 51B.

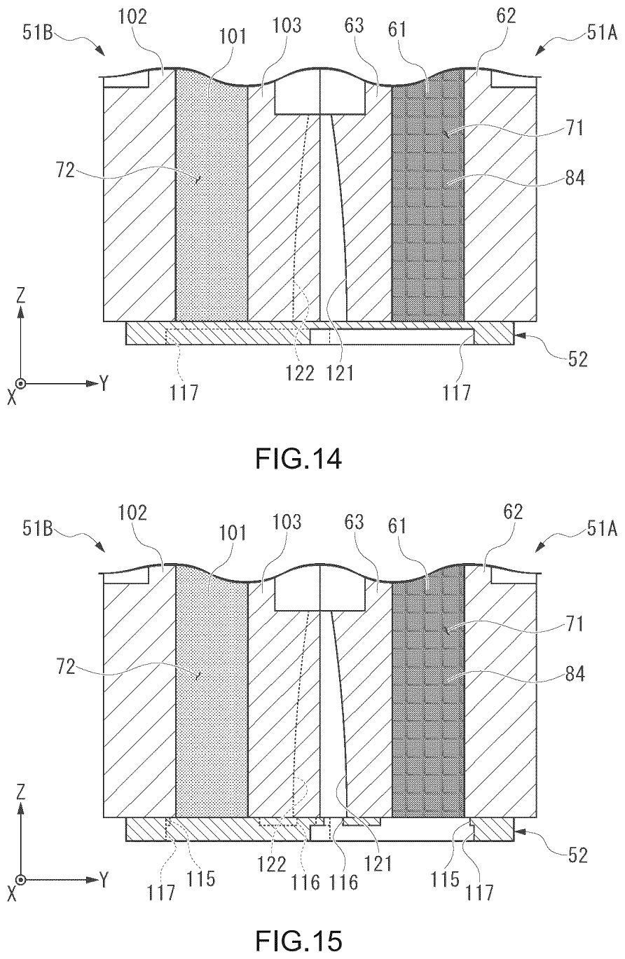

In the return plate processing step S4, the communication channels 110, 111 are provided to portions overlapping the ejection channels 71 when viewed from the Z direction of the return plate 52. The communication channels 110, 111 are formed by performing, for example, laser processing on the return plate 52. Specifically, in the return plate processing step S4, a first processing step of forming the connecting parts 117 is performed, and then a second processing step of forming the upstream openings 115 and the downstream openings 116 is performed. As shown in FIG. 14, in the first processing step, formation areas of the connecting parts 117 is scanned with a laser in the X direction and the Y direction to form the connecting parts 117 each recessed with respect to the lower surface of the return plate 52. As shown in FIG. 15, in the second processing step, formation areas of the upstream opening 115 and the downstream openings 116 in bottom surfaces of the connecting parts 117 are scanned with the laser to thereby penetrate the return plate 52. Thus, the connecting parts 117 are communicated with the ejection channels 71 through the upstream openings 115, respectively, while the connecting parts 117 are communicated with the connecting channels 121, 122 through the downstream openings 116, respectively. As in the present embodiment, by forming the communication channels 110, 111 in the state in which the return plate 52 is stacked on the chip modules 51A, 51B, it is possible to improve the positional accuracy between the ejection channels 71, and the connecting channels 121, 122 and the communication channels 110, 111. It should be noted that the return plate processing step S4 can be performed using etching or the like besides the laser processing. Further, in the present embodiment, the return plate 52 is bonded to the chip modules 51A, 51B, and then the communication channels 110, 111 are formed, but this configuration is not a limitation. It is possible to provide the communication channels 110, 111 to the return plate 52 using the laser processing, the etching, or the like, and then bond the return plate 52 to the chip modules 51A, 51B.

In the protective film forming step S5, the protective films 125 are formed on the inner surface of the common ink chamber 90, the inner surfaces of the slits 91, the inner surfaces of the ejection channels 71, the inner surfaces of the communication channels 110, 111, the inner surfaces of the connecting channels 121, 122, and the inner surface of the manifold 123. The protective films 125 are formed by depositing a para-xylylene resin material using, for example, a chemical vapor deposition method (CVD).

In the nozzle plate stacking step S6, the nozzle plate 53 is bonded to the lower surface of the return plate 52.

Due to the steps described hereinabove, the head chip 50 is completed. It should be noted that when manufacturing the head chips 50 wafer by wafer, substantially the same step as the chip module forming step S1 described above is performed on an actuator plate wafer, a cover plate wafer, and a back plate wafer to thereby form a stacked body of the wafers. Subsequently, by segmentalizing the stacked body of the wafers, the plurality of chip modules 51A, 51B is taken out. Subsequently, by performing the module stacking step S3 and subsequent steps on the chip modules 51A, 51B thus taken out from the stacked body of the wafers, the head chips 50 are completed.

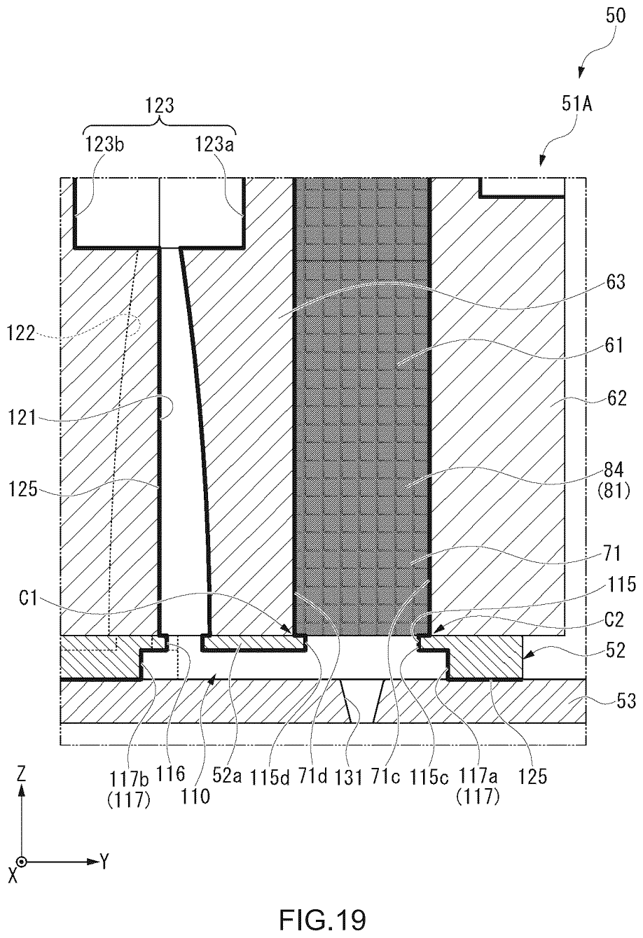

FIG. 19 is an enlarged view corresponding to FIG. 7, and showing a conventional head chip 50. It should be noted that regarding the conventional head chip 50, the constituents corresponding to those of the head chip 50 according to the present embodiment are denoted by the same reference symbols to omit the description.

As shown in FIG. 19, in the conventional head chip 50, the opening edge of the upstream opening 115 is arranged at an inner side of the lower end opening edge of the ejection channel 71 throughout the entire circumference. Therefore, the opening edge of the upstream opening 115 flares from the lower end opening of the ejection channel 71 when viewed from the Z direction to thereby form a flared part (e.g., the upstream back edge part 115c and the upstream front edge part 115d in FIG. 19) between the lower end opening edge of the ejection channel 71 and the opening edge of the upstream opening 115. When the flared part is formed, retention of the ink is apt to occur. When the retention of the ink occurs, there is a possibility that disappearance of the protective films 125 is caused.

In contrast, in the head chip 50 according to the present embodiment, there is adopted the configuration in which the return plate 52 is bonded to the chip modules 51A, 51B so that at least a part of the opening edge in the upstream opening 115 is arranged at the outer side when viewed from the Z direction of the opening edge of the lower end opening of the ejection channel 71.

According to this configuration, since at least a part of the opening edge in the upstream opening 115 is arranged at the outer side when viewed from the Z direction of the lower end opening edge of the ejection channel 71, it is possible to prevent the part (the flared part) flared at the inner side of the lower end opening edge of the ejection channel 71 out of the opening edge of the upstream opening 115 from being formed. Therefore, it is possible to prevent the ink from being retained between the lower end opening edge of the ejection channel 71 and the flared part. Therefore, it is possible to prevent the disappearance of the protective films 125 due to the retention of the ink. Therefore, it is possible to provide the head chip 50 excellent in durability.

Incidentally, a boundary portion between the channel front edge part 71d and the upstream front edge part 117d functions as an inner corner portion C1 when the ink flows into the first communication channel 110 from the ejection channel 71. When the flared part is provided to the inner corner portion C1, the retention of the ink is apt to occur.

In the head chip 50 according to the present embodiment, there is adopted the configuration in which the upstream front edge part (the first upstream edge part) 115d of the upstream opening 115 is located at the −Y side of the channel front edge part (the first channel edge part) 71d of the ejection channel 71.

According to this configuration, it is possible to prevent the upstream front edge part 115d from flaring toward the +Y side with respect to the channel front edge part 71d. Therefore, it is possible to prevent the retention of the ink in the inner corner portion C1.

In the head chip 50 according to the present embodiment, there is adopted the configuration in which the distance in the Y direction between the upstream front edge part 115d and the channel front edge part 71d is no shorter than the dimension (the end surface covering part 52a) in the Z direction in the upstream opening 115.

According to this configuration, since it is possible to make the upstream front edge part 115d sufficiently distant from the channel front edge part 71d, it is possible to prevent the retention of the ink in the inner corner portion C1. In particular, by setting the distance in the Y direction between the upstream front edge part 115d and the channel front edge part 71d to be twice as large as the dimension in the Z direction in the end surface covering part 52a, it is possible to prevent the disappearance of the protective films 125 in the portion covering the common electrode 84 out of the protective film 125 even when the disappearance of the protective films 125 supposedly occurs. As a result, the durability can surely be improved. On the other hand, the distance in the Y direction between the upstream front edge part 115d and the channel front edge part 71d is preferably no larger than 20% of the dimension in the Y direction between the reverse surface of the first back plate 63 and the bottom surface of the first connecting channel 121, and is more preferably no larger than 10% thereof. In this case, since it is possible to ensure a bonding region between the end surface covering part 52a and the lower end surface of the first back plate 63, it is possible to prevent the ink from reaching the common electrode 84 through an interface between the lower end surface of the first back plate 63 and the return plate 52.

In the head chip 50 according to the present embodiment, there is adopted the configuration in which the upstream back edge part (the second upstream edge part) 115c is located at the +Y side of the channel back edge part 71c.

According to this configuration, a boundary portion between the upstream back edge part 115c and the channel back edge part 71c forms an outer corner portion C2 when the ink flows into the upstream opening 115 from the lower end opening of the ejection channel 71. In the present embodiment, it is possible to prevent the upstream back edge part 115c from flaring toward the −Y side with respect to the channel back edge part 71c. Therefore, it is possible to prevent the retention of the ink in the outer corner portion C2.

In the head chip 50 according to the present embodiment, there is adopted the configuration in which the distance in the Y direction between the upstream front edge part 115d and the channel front edge part 71d is longer compared to the distance in the Y direction between the upstream back edge part 115c and the channel back edge part 71c.

In the head chip 50 according to the present embodiment, since the ink enters the connecting part 117 from the upstream opening 115 around the inner corner portion C1, the ink is more apt to be retained in the inner corner portion C1 than in the outer corner portion C2. Therefore, by making the distance in the Y direction between the upstream front edge part 115d and the channel front edge part 71d longer compared to the distance in the Y direction between the upstream back edge part 115c and the channel back edge part 71c as in the present embodiment, it is possible to more surely prevent the retention of the ink in the inner corner portion C1.

In the head chip 50 according to the present embodiment, there is adopted the configuration in which the dimension in the X direction in the upstream opening 115 is smaller than the dimension in the X direction in the lower end opening of the ejection channel 71.

According to this configuration, the return plate 52 and the chip modules 51A, 51B are overlapped with each other so that the opening edge of the upstream opening 115 fits into the inside in the X direction of the lower end opening edge of the ejection channel 71. Thus, it is possible to suppress a variation in communication area between the upstream opening 115 and the lower end opening of the ejection channel 71 due to a processing accuracy and so on compared to when setting the dimension in the X direction in the upstream opening 115 to be equivalent to the dimension in the X direction in the lower end opening of the ejection channel 71. Further, it is possible to prevent the laser beam having penetrated the return plate 52 from reaching the common electrode 84 when providing the communication channels 110, 111 to the return plate 52 using the laser processing or the like after bonding the return plate 52 to the chip modules 51A, 51B. Therefore, it is possible to provide the head chip 50 high in quality. It should be noted that an influence of the laser processing is difficult to occur on the inner side surfaces of the ejection channel 71 on the grounds that the common electrodes 84 are formed thereon, while the retention of the ink is more difficult to occur between the channel side edge parts 71a, 71b and the upstream side edge parts 115a, 115b compared to the inner corner portion C1 or the outer corner portion C2. Therefore, by preventing the flared part in the inner corner portion C1 or the outer corner portion C2 from occurring as in the present embodiment, it is possible to achieve both of the protection of the common electrodes 84 and the retention of the ink.

In the inkjet head 5 and the printer 1 according to the present embodiment, since the head chip 50 described above is provided, it is possible to provide the inkjet head 5 and the printer 1 excellent in durability.

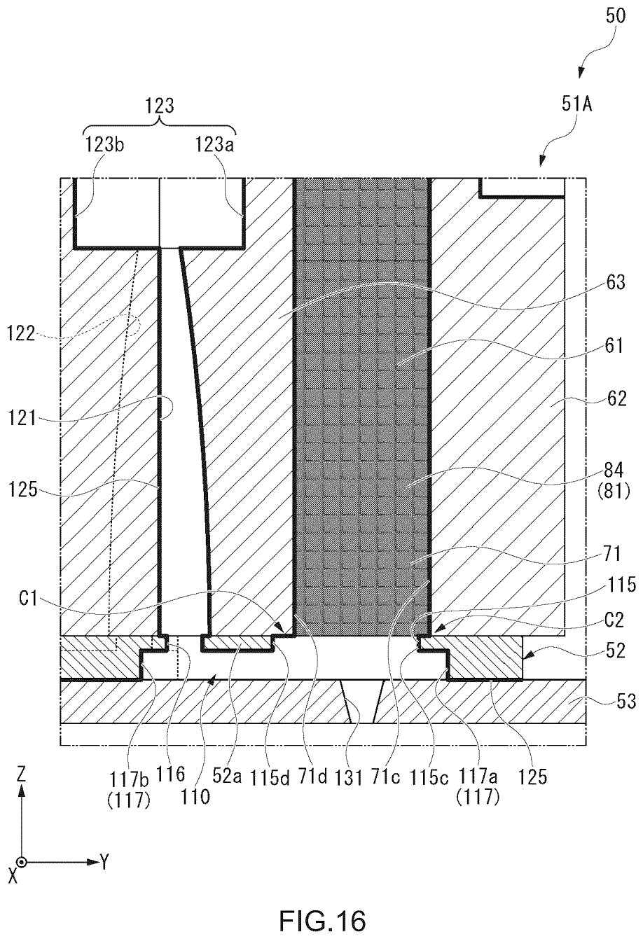

It should be noted that in the first embodiment, there is described the configuration in which the upstream back edge part 115c is located at the outer side in the Y direction of the channel back edge part 71c, and the upstream front edge part 115d is located at the outer side in the Y direction of the channel front edge part 71d, but this configuration is not a limitation. As shown in FIG. 16, it is sufficient for at least the upstream front edge part 115d to be located at the outer side in the Y direction of the channel front edge part 71d.

### Second Embodiment

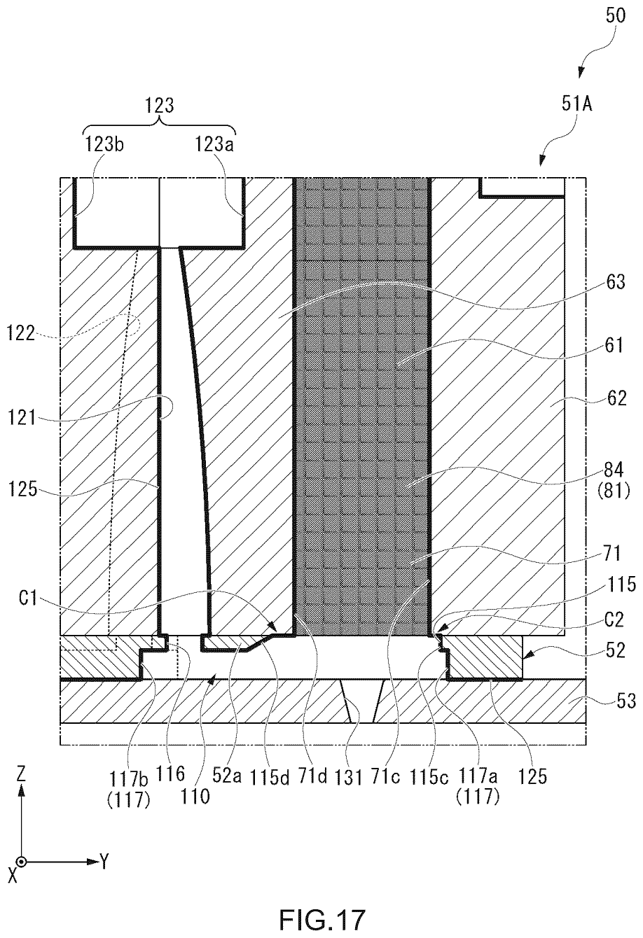

FIG. 17 is a cross-sectional view corresponding to FIG. 7 in a head chip 50 according to a second embodiment.

In the head chip 50 shown in FIG. 17, the upstream front edge part 115d is formed as a tilted surface gradually extending toward the −Y side as proceeding downward.

According to this configuration, it is possible to make the inner corner portion formed between the upstream front edge part 115d and the channel front edge part 71d gentle. Thus, it is possible to make the flow of the ink passing through the inner corner portion smooth. Therefore, it is possible to prevent the retention of the ink in the inner corner portion.

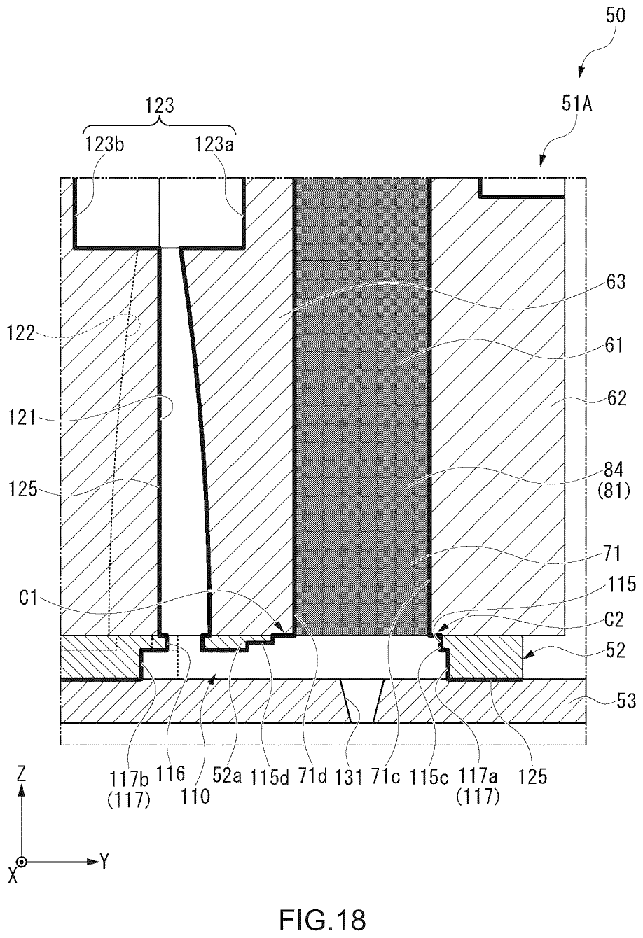

It should be noted that in the head chip 50 according to the second embodiment, there is described the configuration in which the upstream front edge part 115d is formed as the tilted surface, but this configuration is not a limitation. For example, as shown in FIG. 18, it is possible to form the upstream front edge part 115d so as to have a stepped shape.

### Other Modified Examples

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording device, but the liquid jet recording device is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording device, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z direction coincides with the gravitational direction, but this configuration is not a limitation, and it is also possible to set the Z direction to a direction along the horizontal direction.

In the embodiments described above, there is explained the configuration (so-called pulling-shoot) of deforming the actuator plate in the direction of increasing the volume of the ejection channel due to the application of the drive voltage, and then restoring the actuator plate to thereby eject the ink, but this configuration is not a limitation. It is possible for the head chip according to the present disclosure to be provided with a configuration (so-called pushing-shoot) in which the ink is ejected by deforming the actuator plate in a direction of reducing the volume of the ejection channel due to the application of the voltage. When performing the pushing-shoot, the actuator plate deforms so as to bulge toward the inside of the ejection channel due to the application of the drive voltage. Thus, the volume in the ejection channel decreases to increase the pressure in the ejection channel, and thus, the ink located in the ejection channel is ejected outside through the nozzle hole. When setting the drive voltage to zero, the actuator plate is restored. As a result, the volume in the ejection channel is restored.

In the embodiments described above, there is explained the case when the communication channels 110, 111 extend linearly in the Y direction, but this configuration is not a limitation. The communication channels 110, 111 can extend in a direction crossing the Y direction when viewed from the Z direction. Further, the communication channels 110, 111 can each be formed so as to have, for example, a curved shape when viewed from the Z direction.

In the embodiments described above, there is explained the configuration in which at least the upstream front edge part 115d is located at the outer side in the Y direction of the channel front edge part 71d, but this configuration is not a limitation. It is sufficient for at least a part of the opening edge of the upstream opening 115 to be located at the outer side of the lower end opening edge of the ejection channel 71. Further, the amount of retraction and so on with respect to the lower end opening edge of the ejection channel 71 out of the opening edge of the upstream opening 115 can arbitrarily be changed.

In the embodiments described above, there is explained the configuration in which the communication channels 110, 111 are communicated with the lower end opening (the manifold opening) of the manifold 123 via the connecting channels 121, 122, but this configuration is not a limitation. It is possible to adopt a configuration in which the communication channels 110, 111 are directly communicated with the lower end opening of the manifold 123 via, for example, the downstream openings 116.

In the embodiments described above, there is explained the configuration in which the chip modules 51A, 51B are overlapped with each other, but this configuration is not a limitation. It is possible to configure the head chip 50 only with the first chip module 51A.

In the embodiments described above, there is explained the configuration in which the plurality of first communication channels 110 and the plurality of second communication channels 111 are alternately formed in the X direction, and the plurality of first connecting channels 121 and the plurality of second connecting channels 122 are alternately formed in the X direction, but this configuration is not a limitation. It is possible to adopt a configuration in which the plurality of first communication channels 110 and the plurality of second communication channels 111 do not overlap each other (separated in the Y direction) when viewed from the X direction, and the plurality of first connecting channels 121 and the plurality of second connecting channels 122 do not overlap each other (separated in the Y direction) when viewed from the X direction. In this case, it is easy to adjust the dimension between the plurality of first communication channels 110 and the plurality of second communication channels 111, and the dimension between the plurality of first connecting channels 121 and the plurality of second connecting channels 122.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
an ejection section having a plurality of jet channels which extends in a first direction, and which is arranged in a second direction crossing the first direction, and electrodes formed on inner surfaces of the jet channels;
a jet hole plate which has a plurality of jet holes individually communicated with the plurality of jet channels, and which is arranged at a first side in the first direction of the ejection section;
a return plate which has a plurality of communication channels configured to individually communicate the plurality of jet channels and the plurality of jet holes with each other, and which is arranged between the ejection section and the jet hole plate in the first direction;
a flow channel plate which has a manifold communicated in a lump with the plurality of communication channels, and which is arranged at one side in a third direction crossing the second direction when viewed from the first direction with respect to the ejection section; and
a protective film formed throughout the inner surfaces of the jet channels and inner surfaces of the communication channels, wherein
the communication channels each include:
an upstream opening communicated with a channel opening which opens toward the first side in the first direction in the jet channel,
a downstream opening communicated with a manifold opening which opens toward the first side in the first direction in the manifold, and
a connecting part which extends in the third direction, and which is configured to connect the upstream opening and the downstream opening to each other, and
the return plate is bonded to the ejection section so that at least a part of an opening edge in the upstream opening is arranged at an outer side when viewed from the first direction with respect to an opening edge of the channel opening.

2. The head chip according to claim 1, wherein
the opening edge of the upstream opening includes a first upstream edge part located at the one side in the third direction,
the opening edge of the channel opening includes a first channel edge part located at the one side in the third direction, and
the first upstream edge part is located at the one side in the third direction when viewed from the first direction with respect to the first channel edge part.

3. The head chip according to claim 2, wherein
the first upstream edge part increases in dimension in the first direction in a direction toward the one side in the third direction.

4. The head chip according to claim 2, wherein
a distance in the third direction between the first upstream edge part and the first channel edge part is longer than a dimension in the first direction in the upstream opening.

5. The head chip according to claim 2, wherein
the opening edge of the upstream opening includes a second upstream edge part located at another side in the third direction,
the opening edge of the channel opening includes a second channel edge part located at the other side in the third direction, and
the second upstream edge part is located at the other side in the third direction when viewed from the first direction with respect to the second channel edge part.

6. The head chip according to claim 5, wherein
a distance in the third direction between the first upstream edge part and the first channel edge part is longer compared to a distance in the third direction between the second upstream edge part and the second channel edge part.

7. The head chip according to claim 1, wherein
the electrodes are formed on inner side surfaces facing each other in the second direction out of the inner surfaces of the jet channels, and
a dimension in the second direction in the opening edge of the upstream opening is smaller than a dimension in the second direction in the opening edge of the channel opening.

8. A liquid jet head comprising:
the head chip according to claim 1.

9. A liquid jet recording device comprising:
the liquid jet head according to claim 8.
